(19) United States
(12) Patent Application Publication
(10) Pub. No.: US 2014/0061348 A1
(43) Pub. Date: Mar. 6, 2014

(54) REINFORCEMENT STRUCTURE OF PAPER SHREDDER

(71) Applicant: NINGBO OFITECH BUSINESS MACHINESE CO., LTD., (US)

(72) Inventor: Wujun WEI, Ningbo (CN)

(73) Assignee: NINGBO OFITECH BUSINESS MACHINESE CO., LTD., Ningbo (CN)

(21) Appl. No.: 13/858,621

(22) Filed: Apr. 8, 2013

(30) Foreign Application Priority Data
Aug. 31, 2012 (CN) 201220441461.9

(51) Int. Cl. B02C 18/16

(52) U.S. Cl. CPC B02C 18/16
USPC 241/285.1

(57) ABSTRACT

A reinforcement structure of a paper shredder, which includes a cutter shaft assembly having a cutter shaft and a paper guiding pack located outside of the cutter shaft assembly, with two ends of said cutter shaft being arranged on lateral plates, and with said cutter shaft being provided thereon with a paper guiding plate connected to said paper guiding pack, which reinforcement structure is characterized in that said paper guiding pack is provided on two sides with angle irons wrapping the outside of said paper guiding pack, and two ends of said angle irons are fixed to said lateral plates.

### FIELD OF THE UTILITY MODEL

The utility model relates to a paper shredder, in particular to a reinforcement structure of a paper shredder.

### BACKGROUND OF THE UTILITY MODEL

An existing paper shredder cutter consists of a pair of cylindrical hobbing knives arranged in parallel and rotating in opposite directions, which cylindrical hobbing knife includes a cutter shaft and multiple knives sheathed onto the cutter shaft, where the knives cut passing paper into strips or segments. When the paper shredder is in use, the cutter shaft may easily be stretched out and deformed when a force is applied, causing the knives on the cutter shaft to slant so that it is difficult for the knives to completely cut the paper, thereby reducing the paper shredding effect and paper shredding efficiency of the paper shredder.

For this reason, many reinforcement structures have been developed, with the following three types being the majority at present: 1. making use of a thicker cutter shaft than a conventional one for a paper shredder to prevent, by means of the rigidity thereof, the cutter shaft from being stretched out, while it comes to become a paper shredder having a thicker cutter shaft and large knives and requiring a large motor power and a strong gear system, which leading to a high cost; 2. making use of a paper guiding pack packed with sheet metal part provided outside of a cylindrical hobbing knife to prevent the cutter shaft from being stretched out, however, it leads to a need of a special mold required for the sheet metal part, a complicated manufacturing process, a high cost, a poor universality, and a limited supporting strength provided; and 3. making use of a metal support column inserted into the plastic top and bottom covers to prevent the cutter shaft from being stretched out by means of the rigidities of the top and bottom covers and of the plastic paper guiding pack per se, but due to the small supporting strength provided by the plastics and the severe vibration during a paper shredding, it can only be used in small shredders.

### SUMMARY OF THE UTILITY MODEL

The technical problem to be solved by the utility model is to provide a paper shredder reinforcement structure which is of high rigidity, low cost, and good universality.

The above technical problem is solved by the utility model using the following technical solution: a reinforcement structure of a paper shredder includes a cutter shaft assembly having a cutter shaft and a paper guiding pack located outside of the cutter shaft assembly, with two ends of said cutter shaft being arranged on lateral plates, and with said cutter shaft being provided thereon with a paper guiding plate connected to said paper guiding pack, which reinforcement structure is characterized in that said paper guiding pack is provided on two sides with angle irons wrapping the outside of said paper guiding pack, and two ends of said angle irons are fixed to said lateral plates.

According to an embodiment of the present utility model, the lateral plates are fixed to the angle irons by way of that said lateral plates have positioning lugs formed by flanging, and said positioning lugs are pressed tightly against outer surfaces of said angle irons and fixed thereto.

Compared with the prior art, the advantages of the present utility model lie in: as angle irons are common profiles widely used in a variety of industries and have the advantages of quite high rigidity, quite good universality, low cost, without the need for dedicate manufacturing, and ease in purchasing, etc., the stretching out, bending, and deforming of a cutter shaft can be substantially eliminated by means of fixing two angle irons to two sides of a paper guiding pack as support bodies.

### BRIEF DESCRIPTION OF THE DRAWINGS

FIG. 1 is a schematic perspective view of a reinforcement structure according to the utility model;

FIG. 2 is a cross-sectional view of a reinforcement structure according to the utility model;

FIG. 3 is a schematic exploded view of a reinforcement structure according to the utility model.

### DETAILED DESCRIPTION OF THE EMBODIMENTS

The utility model is further described in detail as follows with reference to an embodiment of the accompanying drawings.

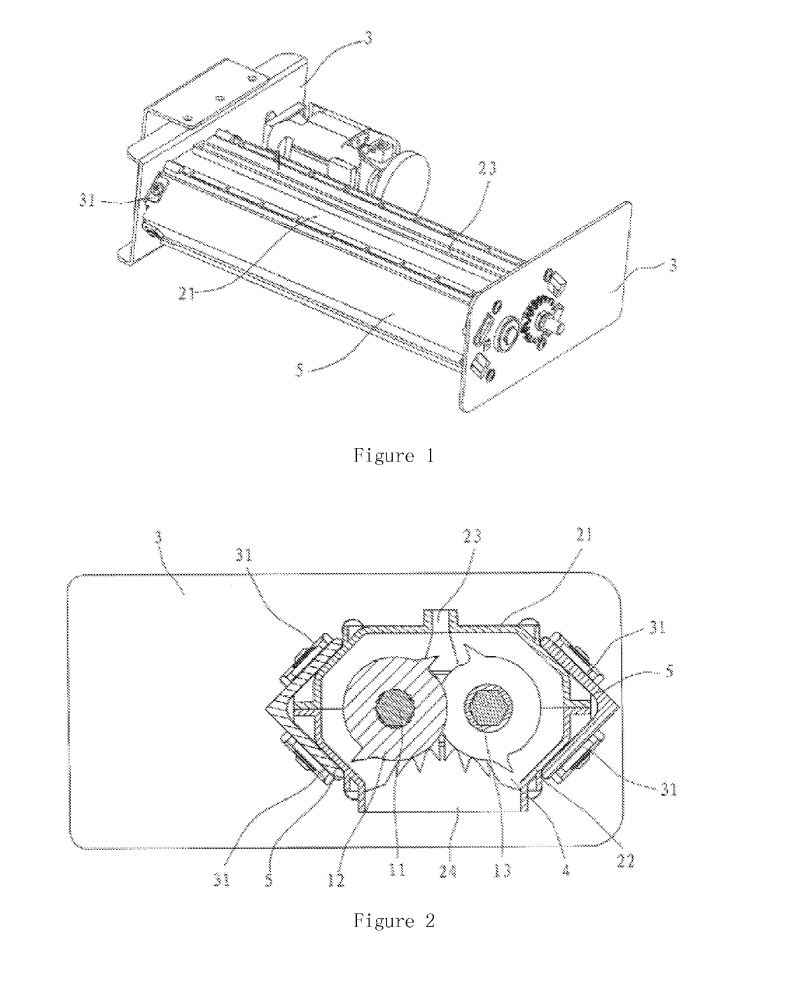

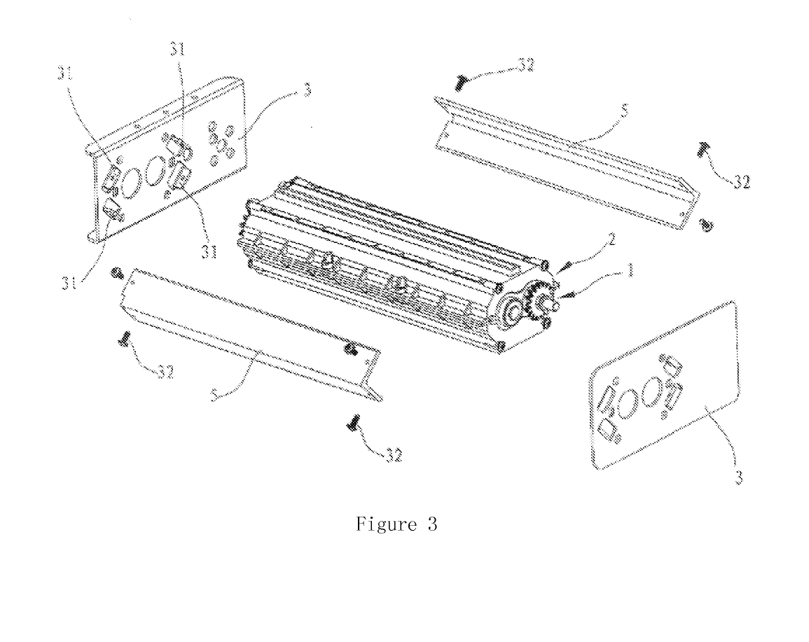

Referring to FIG. 1 to FIG. 3, a reinforcement structure of a paper shredder includes a cutter shaft assembly 1, a paper guiding pack 2 located outside of the cutter shaft assembly 1, and lateral plates 3 located on two ends of the cutter shaft assembly 1.

The cutter shaft assembly 1 includes a cutter shaft 11, knives 12, and cutter rings 13, where the knives 12 and the cutter rings 13 are sheathed onto the cutter shaft 11 in a manner of being spaced apart from each other, and the two ends of the cutter shaft 11 are arranged on the lateral plates 3. The paper guiding pack 2 includes an upper paper guiding pack 21 and a lower paper guiding pack 22, with the upper paper guiding pack 21 having a paper inlet 23, and the lower paper guiding pack 22 having a paper outlet gate 24. A paper guiding plate 4 is provided between the upper paper guiding pack 21 and the lower paper guiding pack 22, where the paper guiding plate 4 is sheathed onto the cutter ring 13 in a manner of cylindrically contacting the cutter ring 13.

On the left and right outer sidefaces of the paper guiding pack 2 there are respectively provided with an angle iron 5, where the angle irons 5 wrap the outer sidefaces of the paper guiding pack 2 and are fixed to the lateral plates 3 at the two ends thereof. The lateral plates 3 are sheet metal parts, with each of the lateral plates 3, in a preferred embodiment, having four positioning lugs 31 formed by flanging. Two edges of the angle iron 5 are respectively fixed via one positioning lug 31, where each of the positioning lugs 31 slants at the same angle as the respective edge of the angle iron 5. Thereby, pressing the positioning lugs 31 tightly against the outer surfaces of the angle irons 5, and fastening the angle irons 5 to the positioning lugs 31 by screws 32, so as to fasten the angle irons 5 to the lateral plates 3.

When the paper shredder is in use, the cutter ring 13 rotates in a round hole of the paper guiding plate 4, the cutter shaft 11 is applied with a bending force directing toward the two sides, the cutter ring 3 transfers the force to the paper guiding plate 4, and the paper guiding plate 4 transfers the force evenly to the upper paper guiding pack 21 and the lower paper guiding pack 22 connected thereto. Because the angle irons 5 are of quite good rigidities, they will, after wrapping the outer sidefaces of the paper guiding pack 2, provide a counterforce which is transferred to the cutter shaft 11, thereby protecting the cutter shaft 11 from deforming.

The description above is merely a preferred embodiment according to the utility model, and it should be noted that for those ordinary skilled in the art various modifications and improvements may be made without departing from the principle of the present utility model, which shall fall within the scope claimed by the utility model.

What is claimed is:

1. A reinforcement structure of a paper shredder, comprising a cutter shaft assembly (1) having a cutter shaft (11) and a paper guiding pack (2) located outside of the cutter shaft assembly (1), with two ends of said cutter shaft (11) being arranged on lateral plates (3), and with said cutter shaft (11) being provided thereon with a paper guiding plate (4) connected to said paper guiding pack (2), characterized in that said paper guiding pack (2) is provided on two sides with angle irons (5) wrapping the outside of said paper guiding pack (2), and two ends of said angle irons (5) are fixed to said lateral plates (3).

2. The reinforcement structure of a paper shredder according to claim 1, characterized in that said lateral plates (3) have positioning lugs (31) formed by flanging, and said positioning lugs (31) are pressed tightly against outer surfaces of said angle irons (5) and fixed thereto.
